(19) United States
(12) Patent Application Publication
(10) Pub. No.: US 2018/0321830 A1
(43) Pub. Date: Nov. 8, 2018

(54) SCREEN-BASED WORKFLOW CONFIGURATION AND EXECUTION PLATFORM

(71) Applicant: Espressive, Inc., Santa Clara, CA (US)

(72) Inventors: Patrice Ronald Calhoun, Sunnyvale, CA (US); Brian James Espinosa, San Jose, CA (US); Francisco Fernandez, Castro Valley, CA (US); Daniel Valdivia Milanes, Mountain View, CA (US); Rohit Kumar Suri, Fremont, CA (US)

(73) Assignee: Espressive, Inc., Santa Clara, CA (US)

(21) Appl. No.: 15/586,041

(22) Filed: May 3, 2017

(51) Int. Cl. G06F 3/0484; G06F 9/44

(52) U.S. Cl. CPC G06F 3/04847; G06F 3/04842; G06F 8/35; G06F 8/34

(57) ABSTRACT

A screen-based workflow platform for enabling an administrator to configure an experience is provided. The experience comprises a plurality of sequential workflows, which each comprise sequential activities specific to a user. Each activity corresponds to a screen for interfacing with a corresponding user on a GUI. The platform is operable to configure screen elements within an activity screen template in response to administrator input representing interaction of the administrator with the template screen elements. The platform includes a data structure for each activity. The data structure specifies configured screen elements and user-related data.

### BACKGROUND

### Field of the Disclosure

This disclosure relates to the field of customer service management, and more particularly to configuring and executing workflows.

### Description of Related Art

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In the field of customer service management, particularly information technology service management, conventional customer service processes are generally task-driven. Conventionally, the creation or modification of user-visible screens that follow a task flow requires hard coding of the screens. Some conventional approaches are form-driven, described on one long page with a workflow. To modify a form under the conventional data-driven approach requires coding to change the form, including creating, editing or deleting records to modify the presentation to a user, and coding to change conditions governing task behavior.

Conventionally, a software vendor ships a solution to a customer comprising a platform that separates source code (platform code and a software development kit) from application code that the customer administrator can configure. If the customer wants to change the behavior of the application or add business logic they must change the application code (which is a mix of coding and GUI tools). Typically, after the customer has changed the application code, it is now “owned” by the customer and that part of the application is no longer maintained or updated by the software vendor. These platforms thus require extra management by the customer to maintain what the customer has updated. Using this approach, the software development, integration, and verification of any code modifications can take months.

Moreover, conventional workflows often appear to users as fragmented, unrelated steps and tasks that do not make sense to users. Conventional software employs workflow engines that perform transactions and evaluate logic, but many actions of the workflow engine are not reflected on the user screens. For example, some workflow tasks may require back end processes invisible to the user, such as order fulfillment performed by a third party, whereas other tasks may be reflected at least partially on a display screen interface. In fact, in many conventional systems, the end user receives an email with a link. When the user clicks on the link, it brings up a screen into which must enter data. Upon submitting the form, the workflow proceeds. The user may receive multiple emails for the same workflow if there are multiple steps involved in the workflow.

### SUMMARY OF THE DISCLOSURE

Embodiments of the disclosure overcome the disadvantages of conventional workflow programming approaches. An administrator (alternatively referred to herein as an “admin”), typically an information technology manager of a customer of the platform provider, configures workflows for execution by users. According to embodiments of the disclosure, a workflow platform enables the admin to develop a series of user-specific workflows that guides multiple users through a business process via a collection of guided screens reflecting activities within each workflow.

The workflow platform of embodiments of the disclosure enables the administrator to program the workflows by configuring pre-defined activity templates, without the need for any coding. During runtime, each activity within a workflow may perform an off-screen, real world action that is reflected on-screen to the user. Activities may interoperate with automated “off-screen” functionality and exchange data with other software modules, including third-party software, through application program interfaces (APIs).

In particular, to configure the workflows, the admin uses screen-based interactions to configure an “experience” for one or more users. An experience comprises a plurality of workflows, wherein each workflow is specific to a “persona,” and comprises one or more activities. A persona represents a user, e.g., a user role such as a hiring manager in an employee onboarding experience. During runtime of the workflow, the persona will be one specific person, e.g., hiring manager John Smith. Each activity corresponds to an activity screen for interfacing with a corresponding user on a corresponding graphical user interface (GUI) during runtime of the workflow. During runtime, a screen may dynamically display screen elements on the client side, changing the screen elements in response to user interaction with the screen.

According to embodiments of the disclosure, during runtime the workflow platform guides a user through a workflow with a series of user-interactive activity screens—a wizard-like user interaction. Thus, the user need not jump between different platforms to complete a workflow, or even between different screens on the same platform. In some conventional approaches, the user would need to know where to go inside or outside a platform in order to complete each part of a workflow.

According to embodiments of the disclosure, the workflow platform enables the admin to configure a workflow by selecting an activity template from a GUI display of a set of predefined activity templates, where each template defines the screen elements (blocks) and their layout on the corresponding screen. The admin may select, for inclusion within an activity, screen element options from within a set of predefined screen element options displayed on the GUI.

In embodiments of the disclosure, the workflow platform also enables the admin to configure conditions governing behavior of screen elements within an activity screen, behavior from one screen to another, or from one workflow to another, by selecting conditions from a predefined set of condition options displayed on a GUI.

As noted above, conventional workflow platforms separate application source code from user interface code that the customer admin can modify. Conventional platforms also render pages in a user interface in real time by having the platform interpret data stored in tables (and/or xml files). In contrast, embodiments of the present disclosure do not expose source code to customers, thus preventing the customer admin from creating error-prone software not verified by the provider of the platform. Instead of giving admins full access to the application code, embodiments of the disclosure give admins a “designer” tool that allows them comparable power, but takes away their ability to “break the code.” Thus, embodiments of the disclosure enable admins to have the power and flexibility of a platform (creating and editing a user experience) without the prior art penalty of bugs and outages, and the burdens of integration and testing created by admins modifying the application source code.

### BRIEF DESCRIPTION OF THE DRAWINGS

FIG. 1 illustrates a screen-based workflow platform for configuring and running workflows, according to embodiments of the disclosure.

FIG. 2 illustrates a workflow data structure employed in a screen-based workflow platform according to embodiments of the disclosure.

FIG. 3 illustrates an exemplary activity screen template and a corresponding activity screen, according to embodiments of the disclosure.

FIG. 4 illustrates an example of a workflow engine implementing an experience, according to embodiments of the disclosure.

FIG. 5 illustrates a GUI upon which an admin can create and edit workflows and activities, according to embodiments of the disclosure.

FIG. 6 illustrates an example of an admin adding a new workflow to the experience of FIG. 5.

FIG. 7 illustrates activities within a workflow of FIG. 6.

FIG. 8 illustrates an example of the configuration of an activity, according to embodiments of the disclosure.

FIG. 9 illustrates the addition of a new activity to a workflow, according to embodiments of the disclosure.

FIGS. 10A and 10B illustrate steps for adding a new condition to an activity, according to embodiments of the disclosure.

FIG. 11 illustrates configuration of an activity, according to embodiments of the disclosure.

FIG. 12 illustrates a preview of an activity screen along with a template for configuring the screen, according to embodiments of the disclosure.

FIG. 13 illustrates the addition of an activity template from a template library, according to embodiments of the disclosure.

FIG. 14 illustrates an activity template divided into blocks, according to embodiments of the disclosure.

FIG. 15 illustrates an example of an admin configuring the newly added activity screen, according to embodiments of the disclosure.

FIG. 16 illustrates a workflow engine enabling the configuration of blocks within an activity screen, according to embodiments of the disclosure.

FIGS. 17A-17E illustrate a workflow engine enabling configuration of the behavior of activities within a screen, according to embodiments of the disclosure.

FIG. 18 illustrates a cloud computing environment according to embodiments of the disclosure.

FIG. 19 illustrates an example of a computer system that may be used to execute instructions stored in a non-transitory computer readable medium (e.g., memory) in accordance with embodiments of the disclosure.

### DETAILED DESCRIPTION

The present description is made with reference to the accompanying drawings, in which various example embodiments are shown. However, many different example embodiments may be used, and thus the description should not be construed as limited to the example embodiments set forth herein. Rather, these example embodiments are provided so that this disclosure will be thorough and complete. Various modifications to the exemplary embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein.

Embodiments of the present disclosure provide a screen-based workflow platform for enabling an admin to configure an “experience” for one or more users. An experience comprises a plurality of workflows, wherein each workflow is specific to a “persona,” and comprises one or more activities. In embodiments, an “activity” is a single screen or off-screen action represented on a screen and that may be triggered by a condition in a workflow. In embodiments, a “persona” refers to a role performed by a user during runtime of the workflow. Each activity corresponds to a screen for interfacing with a corresponding user on a corresponding graphical user interface (GUI) during runtime of the workflow. During runtime, each activity may interoperate with automated “off-screen” functionality and content through application program interfaces (APIs). Some of the off-screen functionality may reside in third-party software integrated with the platform via APIs.

As used herein, an “administrator” (“admin”) refers to one who has privileges to configure an experience. The admin typically may work for an organization, such as a business, that is a customer of the workflow platform provider. A “user” generally refers to an end-user that is guided by activity screens through one or more workflows of the experience during runtime execution. For the sake of convenience, the term “user” shall be used in the claims to refer either to a specific user or a user role, as would be appropriate in the context of the claim to one skilled in the art.

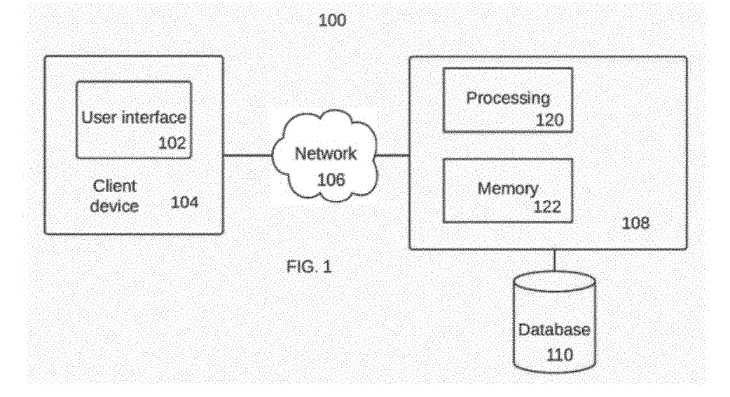

FIG. 1 illustrates a distributed system 100 for implementing a screen-based workflow platform (alternatively referred to herein as a “workflow engine”) on one or more processors using one or more memories for configuring and running workflows, according to embodiments of the disclosure. A user interface 102 includes a client-side interface such as a graphical user interface (GUI). A user interface of the type represented by user interface 102 may be employed by the admin during configuration of the workflow engine. A similar user interface 102 may be employed by a user during runtime. The user interface 102 may reside at a client-side computing device 104, such as a mobile device, or a laptop or desktop computer. The client-side computing device 104 is coupled to one or more servers 108 through a network 106, such as the Internet. The server(s) 108 are coupled locally or remotely to one or more databases 110, which may store objects described herein, such as workflows, activities, workflow and activity templates, and definitions of screen elements (otherwise known as “blocks” herein).

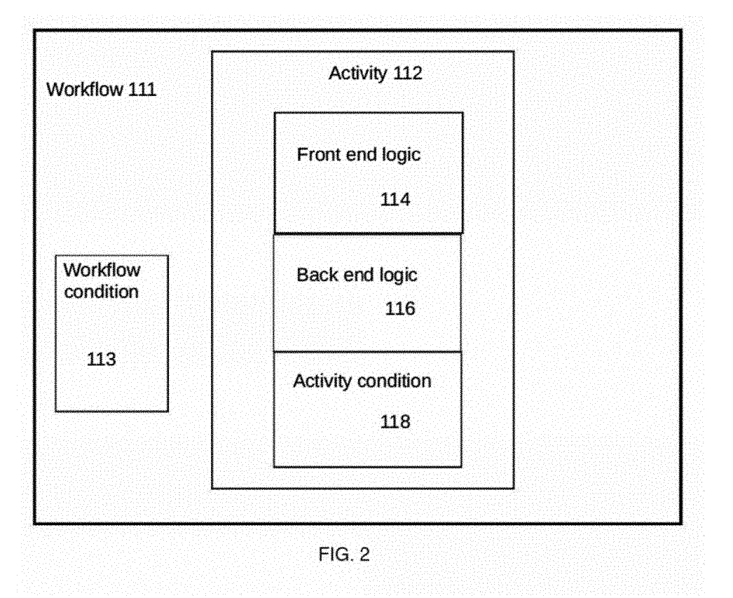

The server 108 may store in the database(s) 110 multiple workflow data structures of the type represented by workflow data structure 111 (shown in FIG. 2), which itself includes workflow condition group 113 and activity data structures of the type represented by activity data structure 112, according to embodiments of the disclosure. The activity data structure 112 may include front end logic 114, back end logic 116, and activity condition group 118.

In embodiments, one or more processors 120 and program and data memory 122 of server(s) 108 constitute the workflow engine that executes computer-executable program code to configure workflows and activities within workflows. In embodiments of the disclosure, the workflow engine may be implemented only on client device 104, only on server(s) 108, or distributed between client device 104 and server(s) 108. In embodiments, the workflow engine may also execute workflows and activities within workflows. In embodiments, the workflow engine may be considered to also comprise workflow condition group 113 and activity condition group 118.

The back end logic 116 includes instructions for fetching data from database 110. The back end logic 116 provides the fetched data to the front end logic 114 to populate the activity screen during runtime. Based upon the information received from the back end logic 116, the front end logic 114 constructs a screen that it sends to the client-side user interface 102 for rendering. The front end logic 114 includes definitions of screen elements and their layout on a screen (e.g., a configured activity template) based upon the configuration of the activity screen. The back end logic 116 and the front end logic 114 may together be referred to herein as “activity logic 117.” In embodiments described in greater detail below, the back end logic 116 may also provide conditions for the front end logic 114 to embed in the page sent to the client device 104. In that case, a client-side browser may evaluate the conditions.

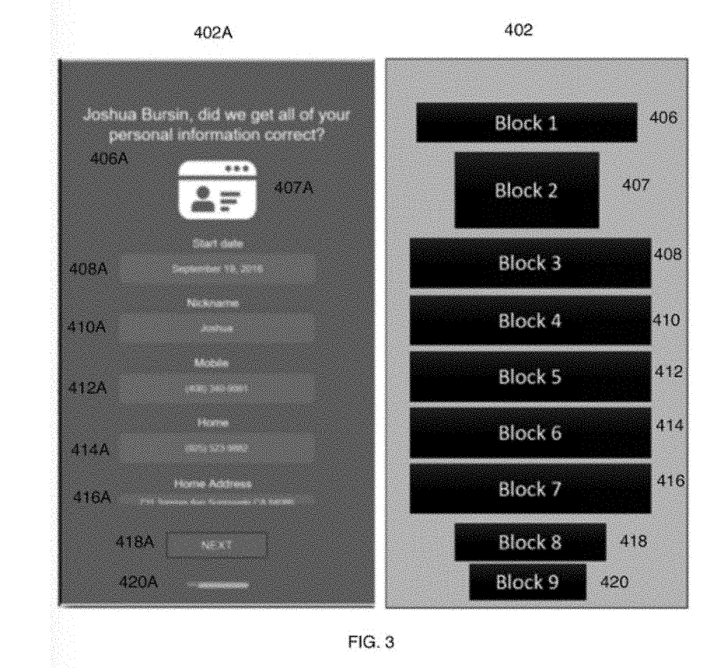

FIG. 3 illustrates an exemplary template 302 and a corresponding activity screen 302A. (The use of templates will be described in more detail below.) The activity screen 302A includes screen elements (blocks). In general, a “screen element” or “block” may include (a) an “active” element on a screen that may be displayed to a user during runtime of the workflow engine, including a user data input field or other element (e.g., interactive icon, checkbox, menu or radio button) that enables user data entry of text, graphics, or other indicia, (b) a “passive” element, such as a text label or graphic that may not itself accept user data or otherwise allow user interaction, or a combination of an active element and a passive element. In this example, the blocks here include user-editable fields such as a graphic 307A, a start date 308A, a nickname 310A, a mobile telephone number 312A, a home telephone number 313A, and a home address 316A. The blocks also include a “NEXT” button 318A enabling user entry of the screen data and triggering the workflow engine to proceed with any subsequent activity, and a progress bar 320A reflecting the progress through the workflow associated with activity 302A.

The database(s) 110 may be local or remote with respect to the client 104 or distributed both locally and remotely. In some embodiments, the workflow engine may run as a cloud-based service, or the workflow engine described herein may run locally on the client device 104. In embodiments, data for use by any locally resident engines may be stored in memory on the client device 104 or in a database accessible by the client device 104.

Workflow data structures of the type represented by workflow data structure 111 are the result of the configuration of workflows and activities within an experience by the workflow engine, according to embodiments of the disclosure. After configuration, the workflow engine may execute the workflows to enable user interaction with the activity screens during runtime, according to embodiments of the disclosure.

In general, any “condition group” referred to herein comprises one or more conditions (e.g., if input1=yes, then go to next activity, if employee=part time, then skip next workflow). The workflow engine may evaluate the conditions within a condition group in an ordered fashion, and execute the first TRUE condition. In embodiments, a condition group 113 may be characterized by at least one condition governing behavior of the activity or workflow, at least one destination activity or workflow that is dependent upon whether a condition is TRUE, and an order for evaluating the conditions.

In embodiments, if the workflow engine evaluates an activity condition group 118 and finds none of the conditions to be TRUE, then the workflow engine ends the workflow, and if the workflow engine evaluates a workflow condition group 113 and finds none of the conditions to be TRUE, then the workflow engine ends the experience.

The workflow engine's evaluation of the activity condition group 118 may determine the next activity to execute within a workflow and whether to proceed with its execution, according to embodiments of the disclosure. The workflow engine's evaluation of the workflow condition group 113 may determine the next workflow within the experience to execute and whether to proceed with its execution, according to embodiments of the disclosure.

In some embodiments, during runtime execution the workflow engine may encounter a shortcut instruction that unconditionally directs execution to the next action, activity or workflow. A shortcut may be treated as a special case in which the shortcut is not considered a “condition” and thus is not a condition that would need to be satisfied or met in order to proceed with the action, activity or workflow specified by the shortcut.

The condition groups described herein may be combined or divided in any manner to achieve the functionality described herein. For example, in embodiments, the workflow condition group 113 and the activity condition group 118 may be combined into one condition group module. In general, all condition groups, whether together or separately, including the workflow condition group 113 and the activity condition group 118, may be referred to herein as the “condition group.”

During runtime execution, the workflow engine may execute instructions to evaluate a condition group to control on-screen and off-screen behavior of the workflows, according to embodiments of the disclosure. In particular, during runtime the workflow engine may execute instructions to evaluate the condition group to generate the activity screens, and to control on-screen behavior from one activity to another within a workflow and from one workflow to another within an experience. In embodiments, during runtime and based upon context and user interaction with the screen, the workflow engine may execute instructions to evaluate the condition group to control off-screen behavior, according to embodiments of the disclosure.

In embodiments, the activity condition group 118 may govern the onscreen behavior within an activity screen by conditioning behavior of activity screen elements based upon (a) user interaction with screen elements on the current screen or on one or more previous screens or (b) context. As mentioned above, in embodiments, the workflow engine may provide these within-activity conditions (e.g., in javascript form) to the client device 104 via the back end logic 116 and front end logic 114, in which case the client-side browser may evaluate the conditions.

In embodiments, the activity condition group 118 may govern flow behavior between activity screens within a workflow based upon (a) user interaction with screen elements on the current screen or on one or more previous screens, (b) completion of a previous activity, or (c) context.

In embodiments, after the last activity in a workflow is completed, the workflow engine turns to evaluation of the workflow condition group 113 to govern the transition between workflows based upon (a) user interaction with screen elements on the current screen or on one or more previous screens, (b) completion of a preceding activity or workflow, or (c) context. The transition between workflows may include determination of the next workflow to which the workflow engine will transition.

The workflow engine may control off-screen behavior through APIs to communicate instructions and data between the workflow engine and software modules that perform the off-screen behavior, such as order placement. Based upon evaluation of the condition group (or unconditioned instructions configured by the admin), the workflow engine enables the off-screen implementation or triggering of workflow tasks corresponding to activities via automation or via human action, e.g., by triggering automated shipping of a product order, or emailing a human to dispatch a product for shipping. In embodiments, the conditions within a condition group may depend upon (a) user interaction with screen elements on the current screen or on one or more previous screens, (b) completion of an activity or workflow, or (c) context. “Context” refers to information concerning the user, including but not limited to information related to user location, user's preferred language, user title, user department membership, user hardware and software environment (e.g., user device type, user device display resolution, user device operating system), user profile information, or user employer.

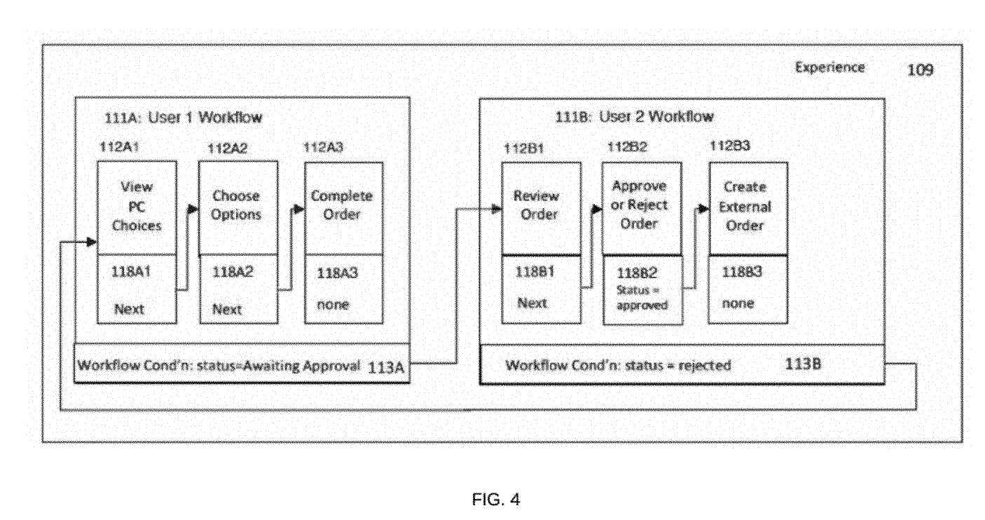

FIG. 4 illustrates an example of the workflow engine implementing an experience 109 to upgrade a user-employee's personal computer (PC). Here, the workflow engine evaluates condition groups to control both off-screen and on-screen behavior. A first workflow 111A enables an employee-user's selection of equipment, and a second workflow 111B enables approval by a manager of the equipment and placement of an order.

Within the first activity “View PC Choices” 112A1 in the first workflow 111A, the user may view PC choices and select a computer model, such as a MacBook, from a variety of purchase options displayed on an activity screen. After completing selection of particular model, the user may hit “enter,” “next” or the like on the GUI screen. The activity condition group 118A1 of the first activity 112A1, like many activity condition groups according to embodiments of the disclosure, may include a first condition such as “if next, then go to activity N” (e.g., here, N=2, Choose Options 112A2). In response to the user's entry of “next” and the workflow engine's evaluation of the first activity condition group 118A1, the workflow engine directs execution flow to a second activity screen 112A2, “Choose Options,” within the first workflow. This activity displays, on the user's GUI, selectable options for the selected MacBook, such as screen size and memory capacity. The user would then select desired options, and click on “next” after completing selection. (For the sake of convenience, the activity logic 117, although present, is not shown in this figure.)

In response, the workflow engine evaluates the second activity condition group 118A2 of the second activity 112A2 to direct execution flow to a third activity 112A3, “Complete Order. This third activity includes no conditions in its activity condition group 118A3. Thus, the workflow engine, upon evaluating this third activity condition group 118A3, ends the workflow 111A and transfers its evaluations to the first workflow condition group 113A. The single workflow action in this group unconditionally sets the user workflow's request status to “awaiting approval” from the manager, and directs execution to the second workflow 111B for manager approval (receiving data entry from the manager) and off-screen ordering of the equipment.

To enable manager review, the first activity 112B1, “Review Order,” in the second workflow 111B displays an activity screen showing an order page based upon the employee's equipment selection. Based on the user's order, the workflow engine may perform off-screen tasks such as computation of product price, shipping and handling costs, and taxes, and populate the manager's screen with those results. Alternatively, instead of performing the off-screen tasks through direct computations, the workflow engine may access third-party software via an API to compute that information.

After the manager (user of this workflow) completes review and clicks on “next,” the workflow engine evaluates the activity condition group 118B1 of this activity to direct execution to the next activity 112B2, “Approve or Reject Order.”

The workflow engine then evaluates the activity condition group 118B2 of the “Approve or Reject Order” activity 112B2, e.g.,
if order=approved, go to “Create External Order” activity 112B3;
if order=rejected, end workflow and defer to workflow conditions 113B

If the manager approves the order, the workflow engine directs execution to the “Create External Order,” the third activity 112B3 in the second workflow 111B. The activity creates and places an off-screen, external order to a third party to fulfill the approved order specified by the employee-user. In embodiments, since there are no activity conditions in this activity condition group 118B3 of the third activity 112B3 of second workflow 111B, the workflow engine ends the workflow 111B and directs evaluation to workflow conditions 113B of the second workflow 111B.

If the manager had rejected the order in the second activity 112B2, then the workflow engine would also have ended the workflow 111B and directed evaluation to workflow conditions 113B of the second workflow 111B.

In this example, the workflow condition group 113B2 includes the condition:
if order status=rejected, end workflow and go to the first activity 112A1, “View PC Choices” of the first workflow 111A [to display the selection screen to the user].

In embodiments, if the order is approved, no conditions remain in the workflow condition group to be met, and the workflow engine defaults to end the workflow as well as the experience. Alternatively, a condition based on order acceptance could have been employed, but that would be unnecessary.

The following describes examples of the configuration of workflows and activities using the workflow engine, according to embodiments of the disclosure.

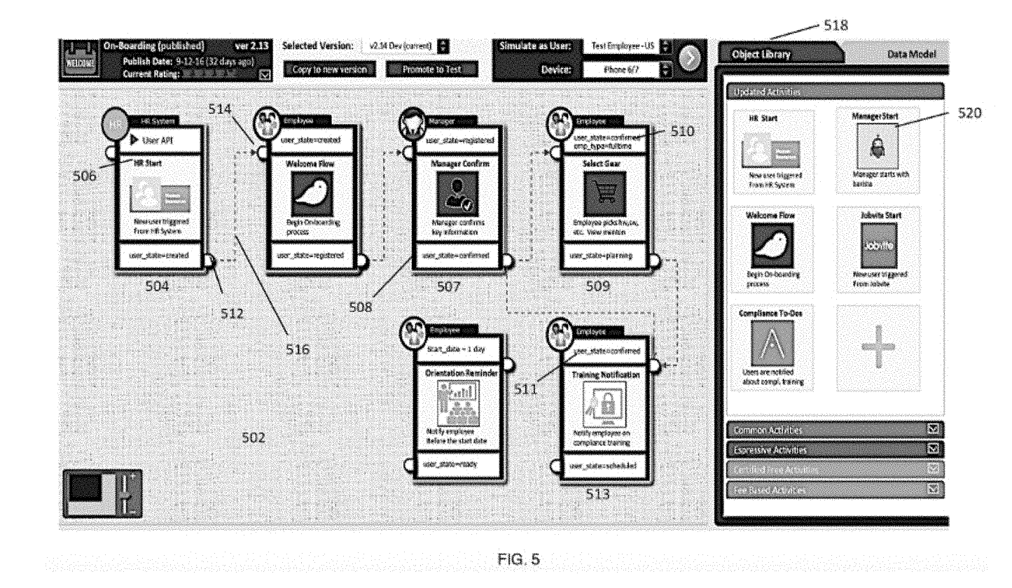

FIG. 5 illustrates a GUI displaying a canvas upon which the admin can create and edit workflows and activities, according to embodiments of the disclosure. This particular canvas displays a schematic of an experience 502 (denoted an “Experience” in the figures) for on-boarding employees into an organization. The workflow engine provides an arrangement of workflow icons on the canvas (such as HR Start workflow icon 504) that each represent a workflow. Each icon may display metadata such as a workflow identifier 506 (e.g., HR Start), an output state 508 (e.g., user_state=confirmed), and a condition group 510 (e.g., user_state=confirmed 508 [AND] emp_type=fulltime) for the workflow (e.g., Select Gear 509). Each icon may include connector nodes connected by connectors (e.g., nodes 512 and 514 connected by connector 516 (in dashed lines)) enabling connection of a workflow to connector nodes of other workflows.

As an example, the workflow Select Gear 509 (e.g., “Employee picks hw, sw, etc.”) follows the workflow Manager Confirm 507 in the employee on-Boarding experience. An output state of the Manager Confirm workflow is “user state=confirmed” 508, representing confirmation that the onboarding user is a valid employee. For this example, assume a user may select gear only if confirmed as a valid employee and assigned full time status. In this example, the workflow condition groups 510 and 511 respectively specify the following conditions to be evaluated in sequential order by the workflow engine.
Condition 1 510: if user_state=confirmed AND emp_type=full time, then go to Select Gear 509;
Condition 2 511: if user_state=confirmed then go to Training Notification 513; Else terminate esperience.

Upon encountering the first condition that is TRUE, the workflow engine directs execution flow to the specified destination.

The canvas also displays an object library 518 of workflow template options (e.g., Manager Start 520). The workflow engine enables the admin to configure the experience by dragging and dropping workflow templates from the object library 518 onto the canvas. Each workflow template is preprogrammed with a default configuration.

The workflow engine enables the admin to connect workflows by creating new connector lines or moving existing connector lines. A connector line 516 depicts a directed flow representing an execution path of program code from one workflow to another. The workflow engine may condition the flow from one workflow to another workflow based on conditions, such as completion of the preceding workflow or the context of the experience.

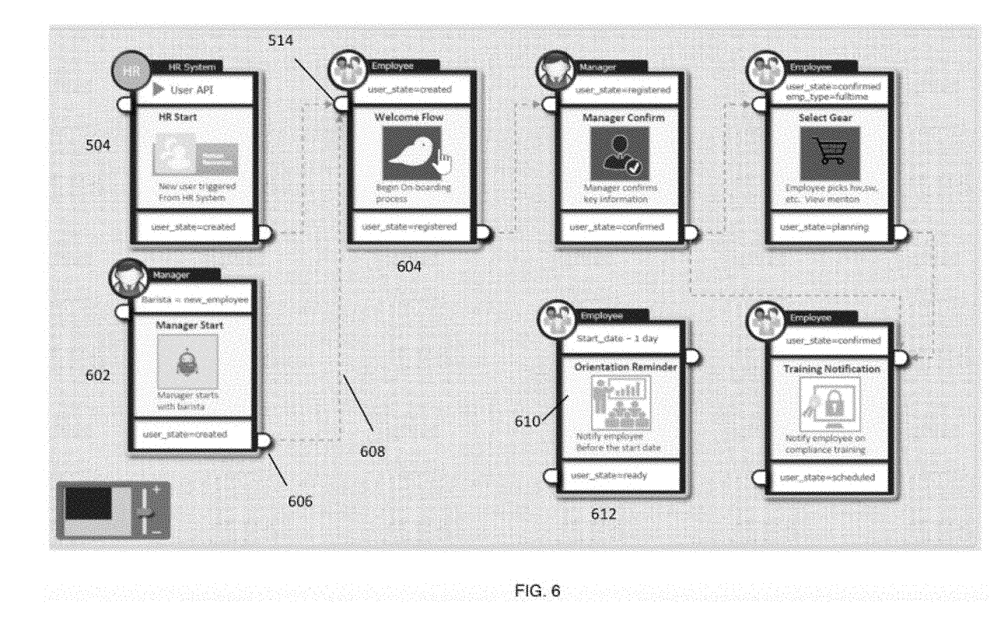

FIG. 6 illustrates an example of an admin adding a new workflow to the onboarding experience of FIG. 5. In FIG. 5, the onboarding experience commences with a new user triggered from the workflow HR Start 504, a (fictitious) third party provider of enterprise software. In this example, the admin wants the option of triggering the onboarding process with other software. To that end, the object library includes the “Manager Start” workflow template option 520 that enables the onboard experience triggering to be initiated through a chatbot (here, denoted “barista”). The chatbot (e.g., like Apple Inc.'s Siri) may gather preliminary data from the manager about a new employee, such as name, start date, and contact information, after which the workflow engine would execute the next workflow in its execution path.

The admin may click on the connector node of one workflow icon to create a new connector line, and drag the connector line to terminate at the connector node of another workflow icon on the canvas. To move an existing connector line, the admin may click on the start or the end terminus of the connector line on one workflow icon and drag the terminus to a different node of another workflow icon.

Thus, as shown in FIG. 6, the admin has added a Manager Start workflow icon 602 to the beginning of the experience by dragging and dropping the corresponding workflow template from the object library. The admin has also connected the output of the newly placed Manager Start icon to the input connector node of the Welcome Flow workflow icon 604 by clicking on the output connector node 606 of the Manager Start workflow and dragging the resulting connector line 608 to the input node 514 of the Welcome Flow workflow icon 604. As a result, the actions of the Welcome Flow workflow 604 can now be triggered by the creation of a new user in the experience from either the HR System Start workflow 504 or the Manager Start workflow 602. The output state of each workflow is the same: user_state=created. This reconfiguration results in a change in the workflow condition group 113 for the Welcome Flow 604, which can be represented in pseudocode as:
If user_state=created from HR System start workflow, receive input for Welcome Flow workflow from HR system workflow;
If user_state=created from Manager Start workflow, receive input for Welcome Flow workflow from Manager Start workflow

An onboarding experience like that of FIG. 6 provides an example of the use of context. Based upon receiving the user's name through the front end logic 114, the workflow engine may learn from a third party database (and not through user input during runtime of the experience in this example) that the employee is not a resident of the United States. Based upon evaluating a residence condition (context in this example) within one of the onboarding activities, the workflow engine would skip asking the employee to fill out their W-4 withholding information, and instead complete the forms necessary for the employee's country of residence.

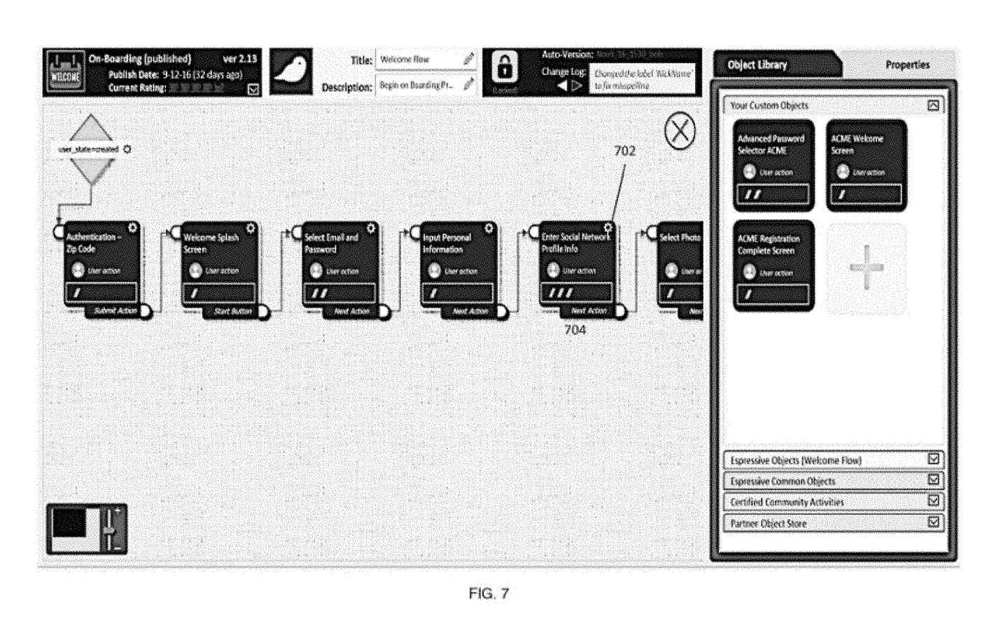

FIG. 7 illustrates the canvas of FIG. 6 after the admin has clicked on the Welcome Flow workflow icon 604 for the On-Boarding experience. The canvas now shows an expanded drill-down of the workflow, showing activities within the Welcome Flow workflow 604. To configure an activity, the admin may click on a properties cog, such as cog 702 of the Enter Social Network Profile Info activity icon 704.

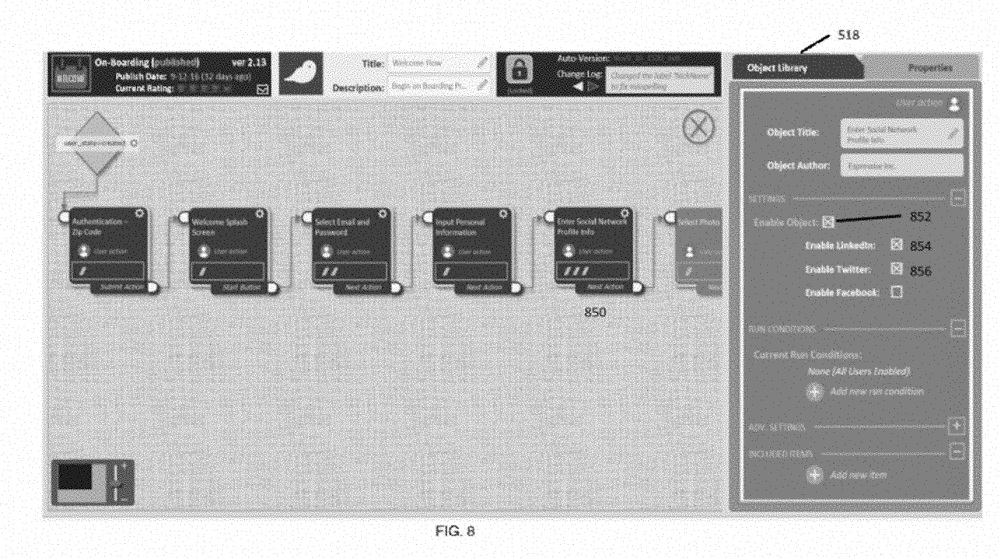

Referring to FIG. 8, the admin's action has opened a window in the Object Library 518, enabling the admin to configure the Enter Social Network Profile Info activity 850 (see Object Title field in Object Library window). Within SETTINGS in the Object Library 518, the workflow engine provides the admin with menu options to enable or disable the object (here, Enter Social Network Profile Info activity 850) by checking/unchecking an Enable Object box 852 to make the activity object appear or not appear, respectively, as an activity within the workflow on the canvas, and, if the object is enabled, to enable selected, predefined social network options (e.g., LinkedIn 854, Twitter 856) to be displayed to the user, and to enable receiving the on-boarding employee's social network information during runtime execution of the activity. In embodiments of the disclosure, the workflow engine enables the admin to make these changes without any coding, but merely by selecting from among predefined options.

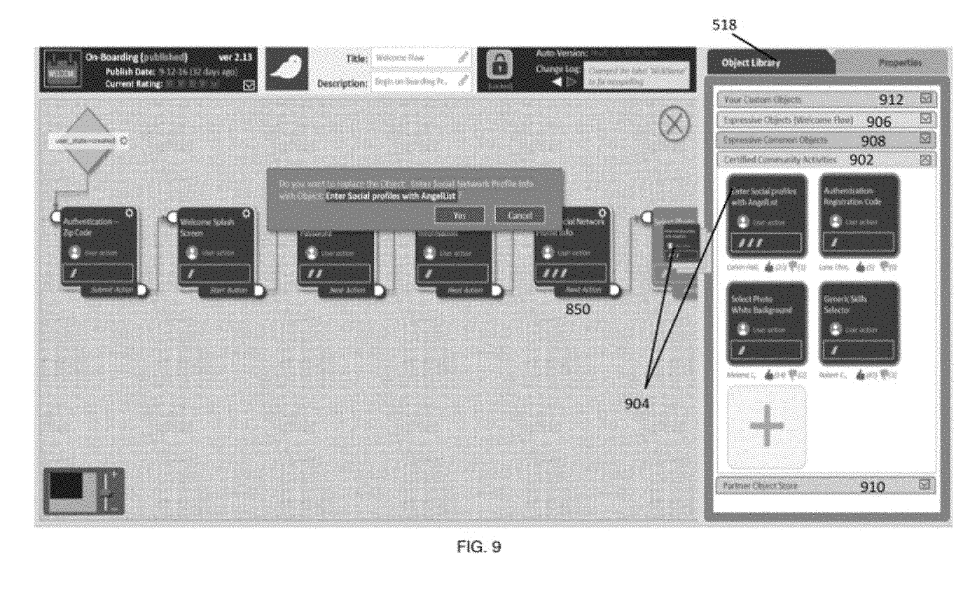

FIG. 9 illustrates the addition of a new activity to the workflow. In embodiments, the admin browses the object library 518, and clicks on the appropriate heading within the object library. In this example, the admin has selected Certified Community Activities 902. The admin drags from the object library 518 the “Enter Social Profiles with AngelList” activity template 904 (the smaller icon 904 illustrates the template being dragged), and drops it on top of the Enter Social Network Profile Info activity icon 850 on the canvas, to replace the latter with the former.

In FIG. 9, the “Espressive objects” template 906 refers to “out-of-the-box” activity objects tailored to a particular workflow (here, Welcome Flow), and which are provided and certified by the provider of the platform as safe, secure, bug-free, and relatively efficient. “Espressive common objects” templates 908 refers to “out-of-the-box” activity objects that can be incorporated into any workflow, and which are provided and certified by the provider of the platform as safe, secure, bug-free, and relatively efficient. “Certified community activities” templates 902 means the provider of the workflow platform has certified customer-created experience objects (e.g., activities, workflows) as safe, secure, bug-free, and relatively efficient for sharing in the certified community activity library. “Partner object Store” 910 means a third-party has created an experience object and the platform provider has certified the object as safe, secure, bug-free, and relatively efficient to run on the platform. “Your custom objects” templates 912 refers to a library created by the customer, but not certified by the platform provider. Thus, the customer runs these “Your custom objects” at their own risk.

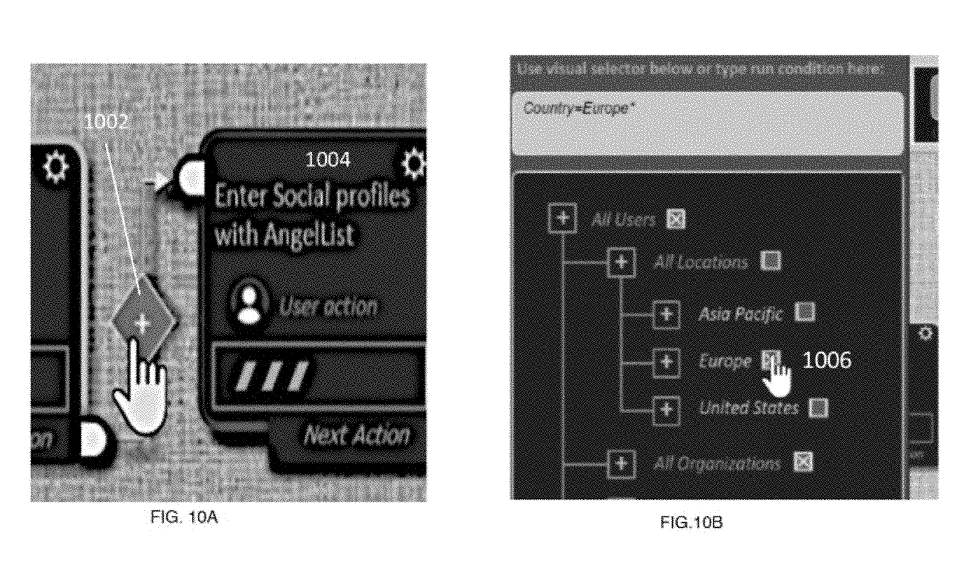

FIGS. 10A and 10B illustrate steps for adding a new condition to an activity, according to embodiments of the disclosure. According to embodiments, the workflow enables an admin to graphically expose a conditions menu to view conditions options. In this example, the admin hovers a cursor over and clicks on a connector line 1002 leading to the activity (here, “Enter Social Profiles with AngelList” 1004) for which the admin wants to add or modify a condition. In response, the workflow engine exposes the conditions menu shown in FIG. 10B.

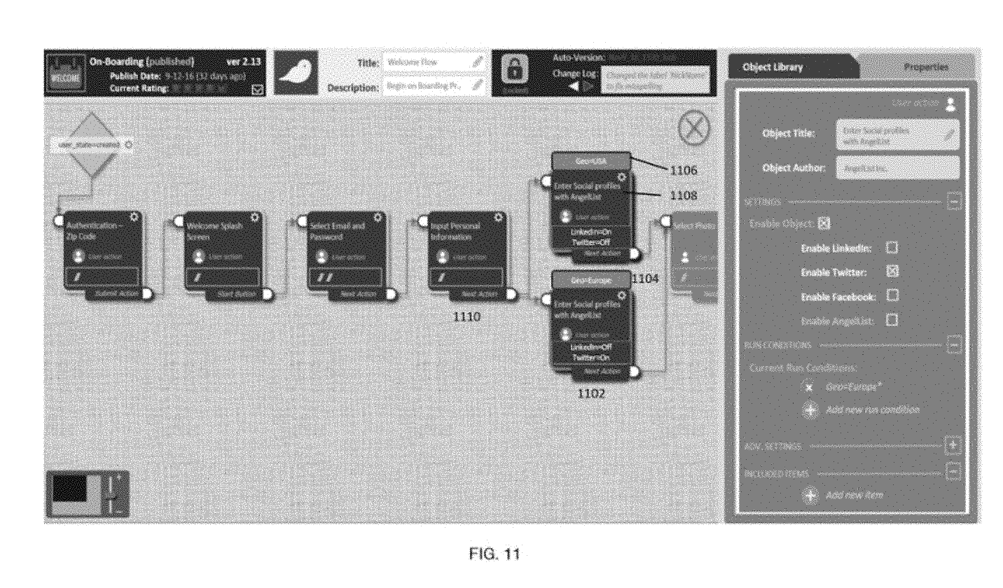

The workflow engine receives an admin's click in a check box 1006 of the menu to enable the activity 1004 for users in Europe. Referring to FIG. 11, this configuration is reflected by the condition 1104 (“Geo=Europe,” i.e., “If geography=Europe, then execute activity 1102”) of the “Enter Social Profiles with AngelList” activity icon 1102.

FIG. 11 also reflects the admin having inserted another instance 1108 of the “Enter Social Profiles with AngelList” activity (by, e.g., dragging and dropping a template from the Object Library), and conditioning its execution on the user location being in the United States. This condition is illustrated with condition 1106 (“Geo=USA”) of activity 1108. Thus, the workflow engine enables the admin to add multiple instances of activities (including duplicates of the same activity), and configure their conditions individually.

The workflow engine performs the above operations without requiring any coding by the admin; the new activities and their settings above are all implemented by modifying data without impacting source code. Even if a conventional system were converted to guide a user through a workflow with a series of screens, changing the screens or screen flow would still require editing and testing of the underlying code under conventional approaches. Since the software platform vendor is typically not involved under the conventional approach, the vendor would not able to upgrade the code that was edited by the customer.

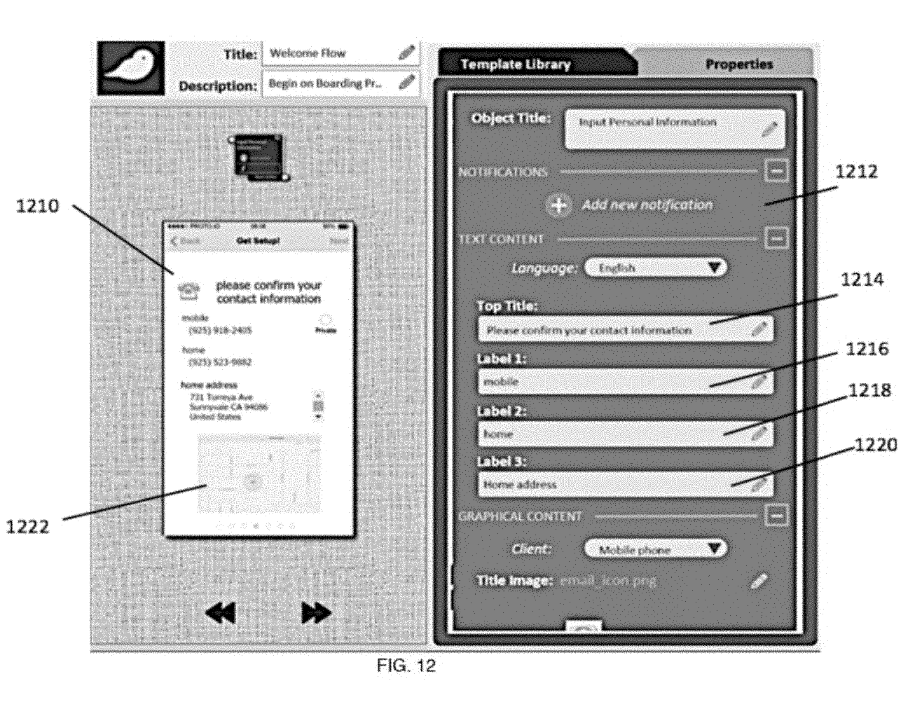

FIG. 12 illustrates an activity screen within the Welcome Flow workflow 604. The workflow engine enables the admin to click on an existing activity icon on the canvas (e.g., “Input Personal Information” activity 1110 from FIG. 11) to expose a preview of a screen 1210 corresponding to the selected activity. The workflow engine enables an admin to add new activities or modify existing activities, and configure content settings on each activity in a live preview mode. The workflow engine enables the admin to configure the screen for the activity by selecting templates (not shown in this figure) from a template library 1212 in the right window and configuring the properties of the activity. In embodiments, the activity templates specify (a) the location of data-entry fields and their corresponding labels within the corresponding activity screen that would be displayed to a user, (b) the behavior of screen elements on the corresponding activity screen; and (c) properties of the screen elements and their behavior that can be modified by the admin.

In this example, the admin configures an activity screen template 1212 set up as shown in the right GUI window. The admin has entered into a “Top Title” field 1214: “Please confirm your contact information.” The Labels under the Top Title represent labels for fields on the screen into which a user of the workflow can enter corresponding information via the GUI. Here, the Label data entry fields 1216, 1218, and 1220 in the template 1212 correspond, respectively, to “mobile,” “home,” and “home address” labels displayed above their corresponding user-entry fields on the screen, and as reflected in activity screen preview template 1210. Any area in the right window (e.g., title, labels, title image) that includes a pencil icon is editable by the admin. In embodiments, an admin cannot modify the labels of the templates, although the admin can change the content of the user-entry fields associated with the labels.

In this example, the workflow engine enables the admin to select from the template an option (not shown) to insert a location-based map 1222—in this case, the location specified by the admin as the home address of the contact. The workflow engine uses an API to activate a mapping engine, such as Google Maps or any other common third-party mapping engine to provide a map of the home address. Similarly, in other embodiments, the workflow engine enables the admin to select from the template a map of the user's current location during runtime, again using an API to activate a mapping engine, such as Google Maps or any other common third-party mapping engine to provide a map of the user's location. The user location is included as context relating to the user.

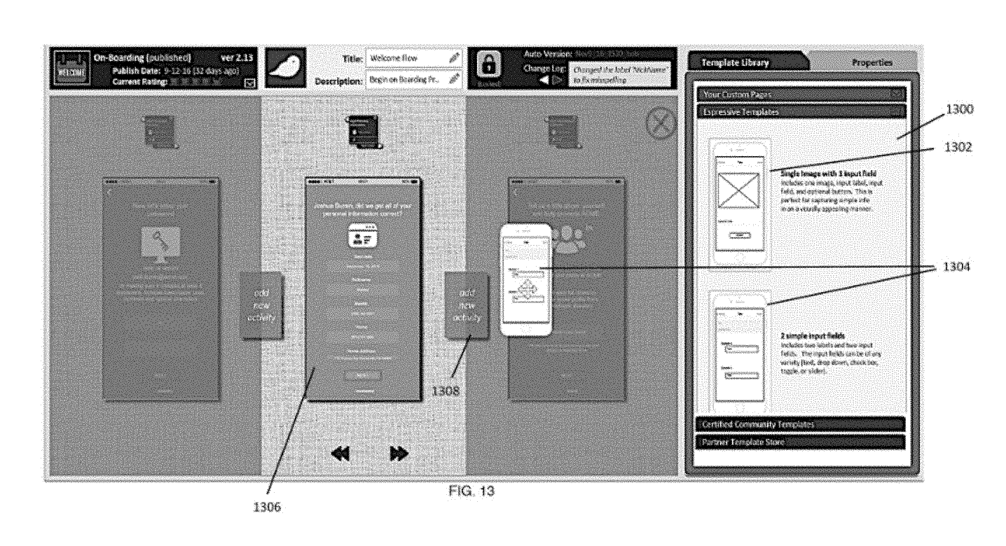

In FIG. 13, the workflow engine enables an admin to select an activity template from the Template Library 1300 to add a new activity to the workflow or replace an existing activity. This example illustrates two template options in the right GUI window: a first option 1302 with a single image and one input field; and a second option 1304 with two simple input fields. The first option includes one image, an input label, an input field for data entry by a user, and an optional button. The second option includes two labels with two corresponding input fields. The input field options include different screen element options, including, for example, text, drop down menu, check box, toggle, and slider.

To add an activity in this embodiment, the admin may select and drag a screen template from the template library 1300 and drop it to the left or right of the current activity screen mockup 1306 (otherwise referred to in this figure as a “page”) being viewed. Intuitively, a template added to the left (right) of the currently viewed screen represents an activity screen that will precede (succeed) the activity corresponding to the currently viewed screen in time. The currently viewed activity screen is the screen on the canvas that is not grayed out. In embodiments, to the left and right of that screen are “add new activity” areas such as area 1308 to which the admin may drop the selected activity template. In this example, the admin has selected the template 1304 (smaller icon version 1304 shows dragging) with two simple input fields.

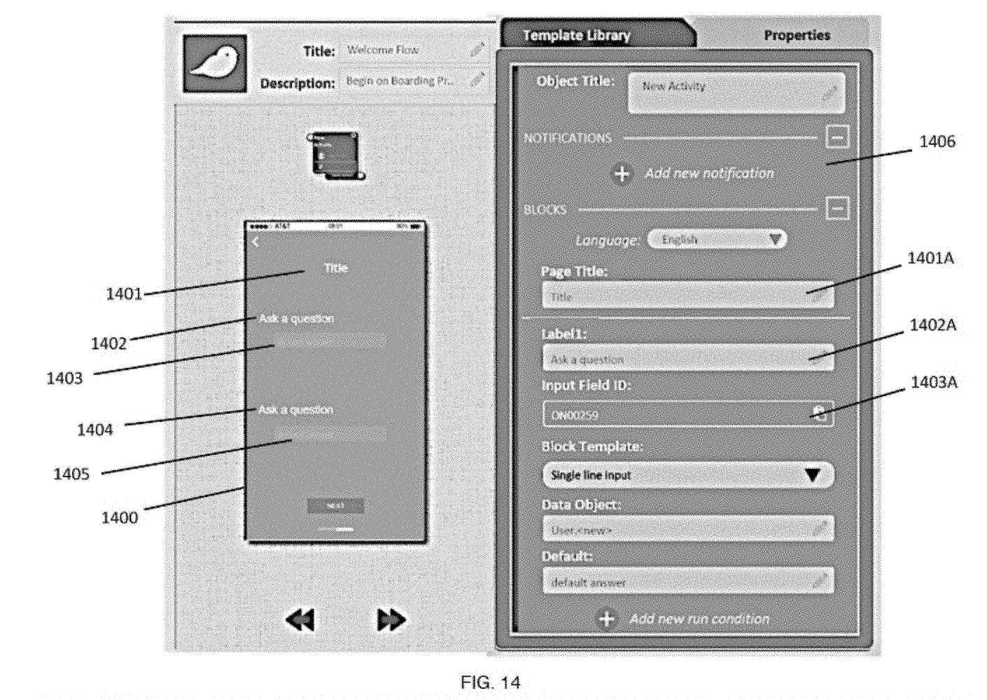

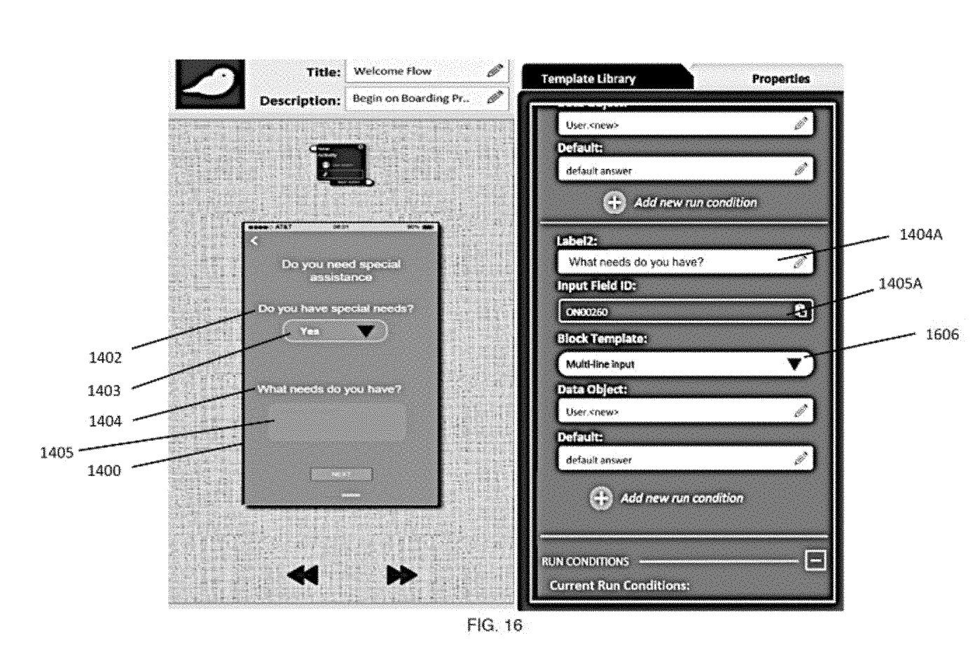

FIG. 14 illustrates the added template as the current activity screen 1400, including Title block 1401, Label1 1402 for the first input block 1403, Label2 1404 for the second input block 1405, along with respectively corresponding data entry areas Page Title block 1401A, and Label1 block 1402A in the Template Library 1406, filled with corresponding default settings. Template data entry area 1404A, shown in FIG. 16, corresponds to Label2 1404. Template Input Field ID areas 1403A and 1405A, shown in this or later figures, correspond to input blocks 1403 and 1405. An activity screen template along with its component blocks may be referred to as a “microtemplate.”

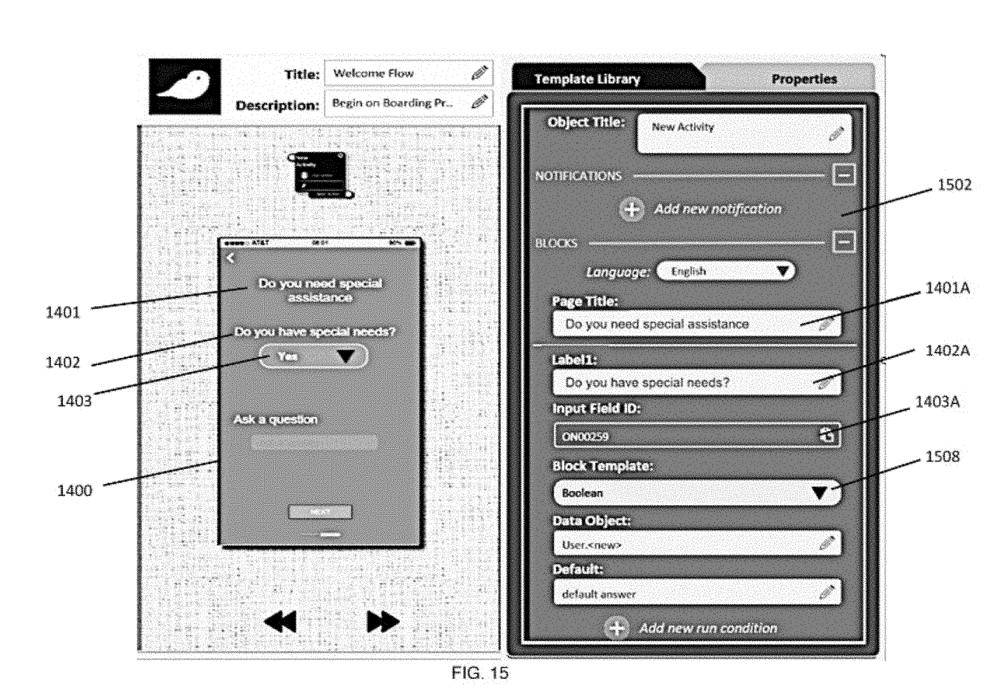

FIG. 15 illustrates an example of the admin configuring the newly added activity screen 1400 in live preview mode to determine whether an onboarding employee has special needs. As reflected in the Template Library 1502, in this example the admin edits the Page Title block template 1401A by typing in desired text—here, “Do you need special assistance.” The admin edits the template label 1402A (Label1) of the first input block 1403 (into which a user would enter a response) and corresponding to label 1402 on the screen 1400 to read: “Do you have special needs?” As shown in the Template Library 1502, the template provides a Block Template 1508 of template options for the first input block. In this example, the admin selects Boolean as the block template from a drop down menu of block template options, causing the screen 1400 to provide the user with an input field 1403 having “yes” or “no” drop down menu options. The canvas shows how the activity screen 1400 appears after the admin's actions in this figure.

FIG. 16 illustrates the workflow engine enabling the admin to edit the label 1404 of the second input block 1405 of the currently active screen 1400. The admin types into the template library Label2 title field 1404A, “What needs do you have?” From a drop down menu of Label2 block template options 1606, the admin selects a multi-line text input option. The currently active screen 1400 shows the results of the admin's actions.

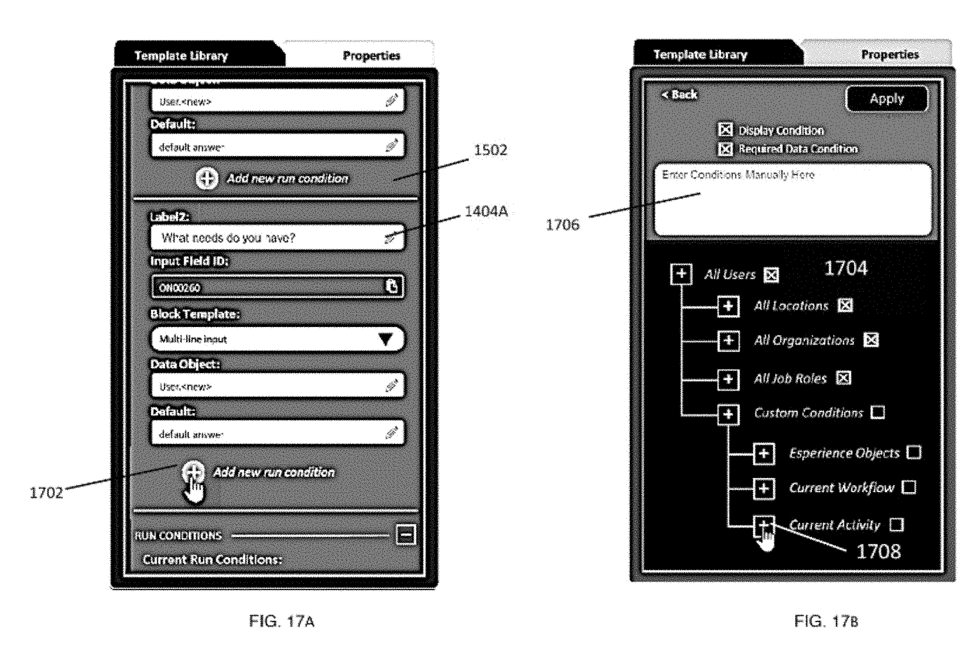

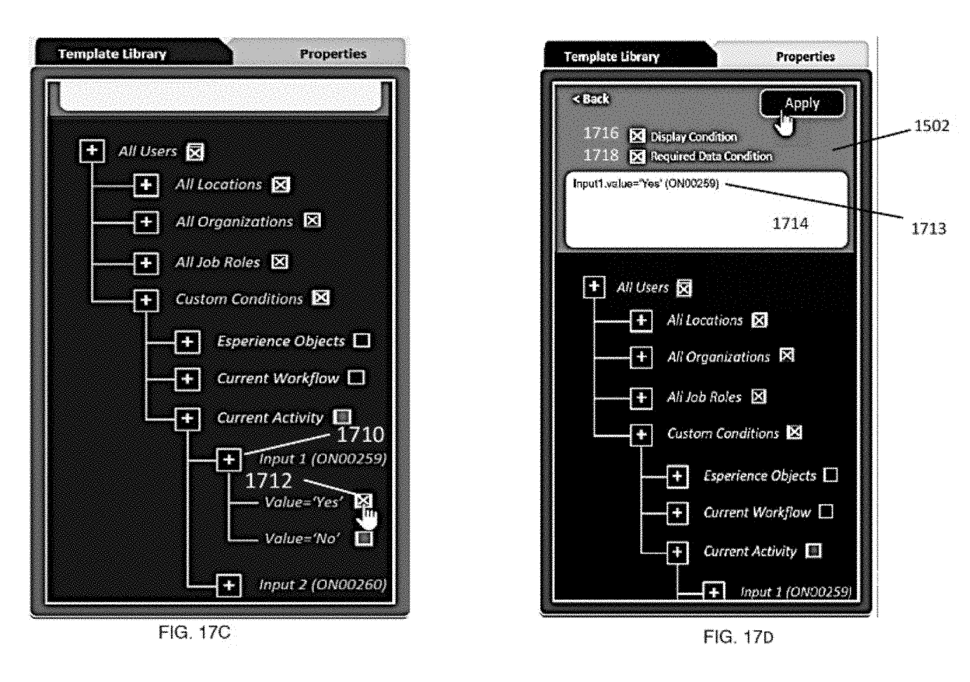

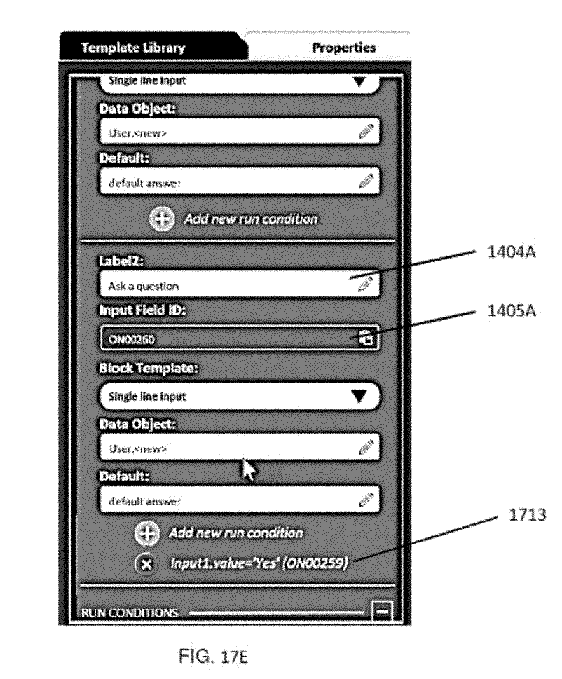

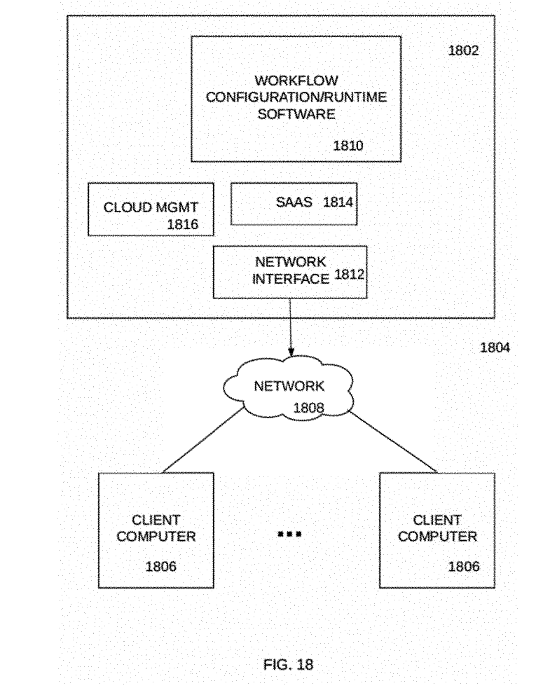

As shown in FIG. 17A, the workflow engine enables the admin to configure the behavior of the activity within a screen by configuring the activity condition group 118. In the current screen of FIGS. 15 and 16, the label 1402 of the first input block 1403 reads: “Do you have special needs?” In this example, the workflow engine enables the admin to configure the condition group 118 to enable the Label2 field 1404 in FIG. 16, “What needs do you have?” to be displayed and to accept user input in input data field 1405 only if the user answers “yes” in the first input block 1403.

In embodiments, the workflow engine provides buttons in the Template Library 1502 of FIG. 17A for the admin to add run conditions (“Add new run condition”) conditioning the behavior associated with the input blocks, particularly, in this example, input block 1405 associated with by Label2 1404. In embodiments, the condition(s) for a block may be generally represented as:
If the run condition for an identified block is true, then execute the actions specified during configuration for that block.

Clicking on the add run condition button 1702 in FIG. 17A causes the workflow engine to display a hierarchical tree 1704, as shown in FIG. 17B. The tree can be expanded by the admin clicking on the node of branches for which the admin wants an expanded set of condition options. In the embodiment of FIG. 17B, the admin may select conditions that are applicable to objects at different hierarchical levels within the entire experience (“Experience”), within the current workflow, or within the current activity. In embodiments, the workflow engine enables the admin to set conditions at different levels within the experience, such as for all or some users of the experience, for all or some locations associated with the selected users, for all or some organizations associated with the selected users, for all or some job roles associated with the selected users. In embodiments of the disclosure, the set of conditions may be pre-defined with the option of customization by the admin.

In embodiments, the workflow engine also enables an admin to change run conditions by clicking on the connector leading to a workflow, such as the connector from Manager Confirm 507 to Select Gear 509, to expose a menu of a predefined set of condition options from which the admin may select Boolean operators and operands to form a conditional expression governing behavior of screens within the workflow, as well as off-screen activities.

As further shown in FIG. 17B, the workflow engine also enables the admin to manually enter conditions in window 1706, or to configure custom conditions from the set of custom condition options in tree 1704. The figure shows the admin clicking on a node 1708 to select custom conditions at the level of the current activity.

As shown in FIG. 17C, the admin's action exposes the input objects for condition options. In this embodiment, those objects are the template versions 1403A, 1405A of first and second input fields 1403, 1405, Input 1 and Input 2. As a reminder, in this example the admin wants to configure the screen conditions to display the Label2 title field 1404, “What needs do you have?” and to accept user input in the corresponding input field 1405, Input 2, only if the user answers “yes” (in field 1403) to the Input 1 question of Label1 1402 (“Do you have special needs?”). To do so, the admin first clicks on the expansion “+” signifier 1710 of the Input 1 condition options to expand the view of the options “Value=‘Yes’” and “Value=‘No’”. In other embodiments, the condition options may take on any form appropriate for the activity, as would be appreciated by one skilled in the art.

Second, as shown, the admin checks the box for the Value=‘Yes’ condition 1712 for Input 1 of the current activity screen in the hierarchical tree. In embodiments, as shown in FIG. 17D the workflow engine also displays the condition 1713 currently being configured (Input1.value=‘Yes’ (ON000259)) in the window area 1714 at the top of the template library view 1502 for the same configuration page as FIG. 17C. The admin then selects the actions to be taken if the value “Yes” were entered by the user in the Input 1 field 1403 during runtime. In this example, as shown at the top of FIG. 17D, the workflow engine displays, in the Template Library window 1502, admin-selectable options to display a condition (“Display Condition”) 1716 and to require data to be input for that condition (“Required Data Condition”) 1718. In this example, the admin has checked both criteria.

Referring to the configuration page of the template library of FIG. 17E, the workflow engine will allow, on the activity screen, the display of Label2 1404 (“What needs do you have?” substituted for the default “Ask a question”) corresponding to template Label2 1404A, and allow user entry of responsive data into the second input field 1405 corresponding to template area 1405A (identified by Input Field ID ON00260) only if the workflow engine has received a “Yes” as input to the first input field 1403 (e.g., Input Field ID ON00259 shown in 1403A) during runtime. This condition on input block 1405 is based upon the admin checking “Required Data Condition” 1718 and selecting condition 1713.

The condition on the second input block 1405 that results from the configuration may be represented in pseudocode as:
If the run condition 1713 on Input 2 1405 is true, then execute actions configured for Input 2 1405

In this example, Input 1 1403 is identified by Input Field ID ON000259 1403A, and Input 2 1405 is identified by Input Field ID ON000260 1405A. More particularly, the condition may be expressed as:
If Input1.value (ON000259)=‘Yes’, then display Label2 1404 and accept data in Input 2 block 1405 (ON000260).

Based on the admin checking “Display Condition” 1716, the workflow engine makes the new condition visible as the question of Label2 (“What needs to you have”) 1404, and saves it in the properties of the activity. Note that the portion of the configuration page showing Label1 1402A and its corresponding first input field 1403A has been scrolled up in this figure and is thus not in view.

The condition is stored in database 110 and accessed by the back end logic 116. During runtime, based upon the admin's configuration, the back end logic 116 fetches from database 110 and sends, to front end logic 114, page data including screen elements layout information (e.g., a template identifier), and any conditions (e.g., in javascript form). The front end logic 114 builds an activity screen (e.g., HTML page) with the page data to send to client device 104 for rendering on user interface 102.

During runtime, based upon context and user interaction with the screen, a client-side browser in user interface 102 may dynamically evaluate the conditions to control the behavior of screen elements and to initiate off-screen activities, such as order placement. In the example above, when the browser first renders the page, it does not expose data input field input 2, because the display condition is not yet true. In response to receiving the user selection of “yes” for input 1, the browser determines whether the condition is met, and, if so, dynamically renders a new screen displaying the screen elements, including data input field input 2. The browser may also dim out the “next” button for taking the user to the next activity screen because it is waiting for entry of data in input 2. Because of the approach implemented by the workflow engine of embodiments, the client device 104 running the user-specific workflow is able to perform these activities without making back and forth calls to the server.

Similarly, in an employee onboarding example, the front end logic 114 provides to the client device 102 page information to render a screen with labels asking for personal information including country of residence, along with a corresponding input field, input 1 for the employee's response. If the employee enters “United States,” then the browser 116 may render a second input field with a label asking for tax information.

When the user requests the next activity (e.g., clicks “Next Action”), the browser sends a request to the front end logic 114 to call the workflow engine to determine the next activity.

The following Table 1 summarizes the configuration and runtime operation of the workflow platform according to embodiments of the disclosure.

TABLE 1

| | Configuration | Runtime |
|---|---|---|
| Page build | | Back end logic fetches and sends, |
| | | to front end logic, page data |
| | | including block data, layout |
| | | information (e.g., template |
| | | identifier), and any conditions |
| | | (e.g., in javascript). |
| | | Front end logic builds page with |
| | | page data to send to client device |
| | | for rendering. |
| Behavior | In response to user | In response to user interaction with |
| within | configuration choices, | a screen element, client-side |
| activity | workflow engine | browser evaluates conditions to |
| | configures | determine next action within |
| | block content, block | activity (e.g., display a |
| | layout, and any | follow-up question input block). |
| | conditions governing | |
| | off-screen behavior | |
| | or on-screen | |
| | behavior of blocks | |
| | within an | |
| | activity screen. | |
| Behavior | In response to user | Based on activity, workflow |
| within | configuration choices, | engine may cause screen |
| workflow | workflow engine | construction or call API for |
| | determines | off-screen action. |
| | activities and their | When user requests next |
| | order within | activity (e.g., clicks “Next |
| | workflow, as well as | Action”), browser calls |
| | conditions governing | workflow engine to evaluate |
| | selection of next | activity conditions to |
| | activity within workflow. | determine next activity. |
| | | If no further activities within |
| | | workflow exist or no conditions |
| | | (within activity condition group) |
| | | are true, then workflow completes. |
| Behavior | In response to user | Upon completion of workflow, |
| within | configuration choices, | workflow engine evaluates |
| experience | workflow engine | workflow conditions to |
| | determines | determine |
| | workflows and their order | next workflow. |
| | within experience, | If no further workflows |
| | as well as | within experience exist or |
| | conditions governing | no conditions (within workflow |
| | selection | condition group) |
| | of next workflow within | are true, then experience |
| | experience, | completes. |

Computer System Implementation

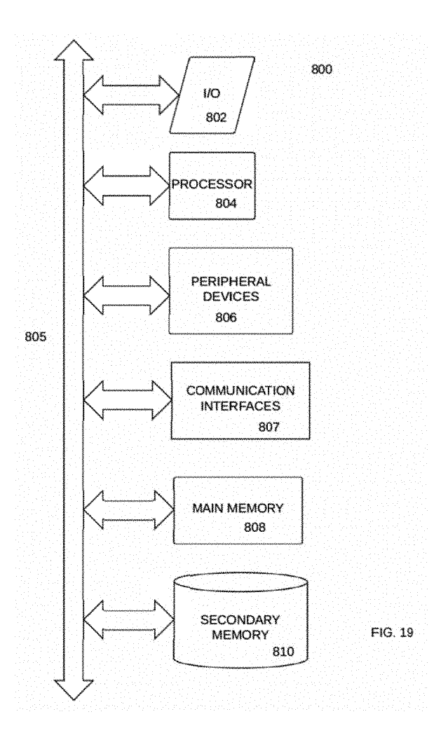

FIG. 18 illustrates a cloud computing environment 1804 according to embodiments of the present disclosure. In embodiments of the disclosure, the software 1810 for the workflow engine may be implemented in a cloud computing system 1802, to enable multiple admins to program workflows/experiences according to embodiments of the present disclosure. Client computing devices 1806, such as those illustrated as client device 104 in FIG. 1, access the system via a network 1808, such as the Internet. The system may employ one or more computing systems using one or more processors, of the type illustrated in FIG. 19. The cloud computing system itself includes a network interface 1812 to interface the workflow engine software 1810 to the client computers 1806 via the network 1808. The network interface 1812 may include an application programming interface (API) to enable client applications at the client computers 1806 to access the system software 1810. In particular, through the API, client computers 1806 may access the workflow engine.

A software as a service (SaaS) software module 1814 offers the workflow engine software 1810 as a service to the client computers 1806. A cloud management module 1816 manages access to the system 1810 by the client computers 1806. The cloud management module 1816 may enable a cloud architecture that employs multitenant applications, virtualization or other architectures known in the art to serve multiple users.

FIG. 19 illustrates an example of a computer system 800 that may be used to execute program code stored in a non-transitory computer readable medium (e.g., memory) in accordance with embodiments of the disclosure. The computer system includes an input/output subsystem 802, which may be used to interface with human users and/or other computer systems depending upon the application. The I/O subsystem 802 may include, e.g., a keyboard, mouse, graphical user interface, touchscreen, or other interfaces for input, and, e.g., an LED or other flat screen display, or other interfaces for output, including application program interfaces (APIs). Other elements of embodiments of the disclosure, such as the workflow engine, may be implemented with a computer system like that of computer system 800.

Program code may be stored in non-transitory computer-readable media such as persistent storage in secondary memory 810 or main memory 808 or both. Main memory 808 may include volatile memory such as random access memory (RAM) or non-volatile memory such as read only memory (ROM), as well as different levels of cache memory for faster access to instructions and data. Secondary memory may include persistent storage such as solid state drives, hard disk drives or optical disks. One or more processors 804 reads program code from one or more non-transitory media and executes the code to enable the computer system to accomplish the methods performed by the embodiments herein. Those skilled in the art will understand that the processor(s) may ingest source code, and interpret or compile the source code into machine code that is understandable at the hardware gate level of the processor(s) 804. The processor(s) 804 may include specialized processing units (e.g., GPUs) for handling computationally intensive tasks.

The processor(s) 804 may communicate with external networks via one or more communications interfaces 807, such as a network interface card, WiFi transceiver, etc. A bus 805 communicatively couples the I/O subsystem 802, the processor(s) 804, peripheral devices 806, communications interfaces 807, memory 808, and persistent storage 810. Embodiments of the disclosure are not limited to this representative architecture. Alternative embodiments may employ different arrangements and types of components, e.g., separate buses for input-output components and memory subsystems.

Those skilled in the art will understand that some or all of the elements of embodiments of the disclosure, and their accompanying operations, may be implemented wholly or partially by one or more computer systems including one or more processors and one or more memory systems like those of computer system 800. In particular, the elements of workflow engine and any other automated systems or devices described herein may be computer-implemented. Some elements and functionality may be implemented locally and others may be implemented in a distributed fashion over a network through different servers, e.g., in client-server fashion, for example. In particular, server-side operations may be made available to multiple clients in a software as a service (SaaS) fashion, as shown in FIG. 15.

Although the disclosure may not expressly disclose that some embodiments or features described herein may be combined with other embodiments or features described herein, this disclosure should be read to describe any such combinations that would be practicable by one of ordinary skill in the art. The user of “or” in this disclosure should be understood to mean non-exclusive or, i.e., “and/or,” unless otherwise indicated herein.

1. A screen-based workflow platform for enabling an administrator to configure an experience, wherein the experience comprises a plurality of sequential workflows, each workflow comprises a plurality of sequential activities specific to a user, and each activity corresponds to a screen for interfacing with a corresponding user on a corresponding graphical user interface (GUI), the platform comprising:
one or more memories storing instructions;
one or more processors coupled to at least one of the one or more memories for executing instructions to cause the platform to:
configure at least one screen element within an activity screen template, that is displayed on a GUI, in response to administrator input representing interaction of the administrator with at least one template screen element, wherein
store a data structure for at least one activity in at least one of the workflows, the data structure for specifying, for display to the user on a screen, the at least one configured screen element.

2. The platform of claim 1, wherein the administrator input comprises selection, for inclusion within an activity, by the administrator of at least one predefined screen element option within the activity screen template displayed on a GUI.

3. The platform of claim 2, wherein types of screen element options include at least text, icons, buttons, sliders, content localization, checkboxes, or text-fillable fields.

4. The platform of claim 1, at least one of the one or more memories storing at least one instruction for configuring at least one condition to control behavior of at least one screen element within the screen, the at least one condition based at least in part upon user interaction with one or more screen elements within the screen or within one or more previous screens in the experience.

5. The platform of claim 1, at least one of the one or more memories storing at least one instruction for configuring at least one condition to control behavior of at least one screen element within the screen, wherein configuring the at least one condition is based at least in part upon selection of the at least one condition from a plurality of condition options displayed on a GUI.

6. The platform of claim 5, wherein the at least one condition is further based at least in part upon a context of the experience.

7. The platform of claim 6, wherein the context is related to at least one of user location, user title, user department membership, user device, or user profile information.

8. The platform of claim 5, at least one of the one or more memories storing at least one instruction for controlling off-screen behavior based at least in part upon satisfaction of the at least one condition.

9. The platform of claim 1, at least one of the one or more memories storing at least one instruction for configuring a workflow in response to selection for inclusion, in a workflow, of one or more activity templates from a plurality of activity template options displayed on a GUI.

10. The platform of claim 9, at least one of the one or more memories storing at least one instruction for positioning on the screen the selected one or more activity templates in functional relationship with at least one other activity template in response to administrator input.

11. The platform of claim 9, wherein types of the activity template options relate to at least user authentication, receiving data entry, data processing, order entry, or order fulfillment.

12. The platform of claim 9, wherein the plurality of activity template options includes a limited set of activity template options provided by a provider of the platform.

13. The platform of claim 1, the data structure further specifying one or more conditions for determining a next activity to perform based at least in part upon one of the one or more conditions being satisfied.

14. The platform of claim 1, at least one of the one or more memories storing at least one instruction for configuring at least one condition to control transition from a first activity to a second activity within a workflow.

15. The platform of claim 14, wherein configuring the at least one condition is based at least in part upon selection of the at least one condition from a plurality of condition options displayed on a GUI.

16. The platform of claim 15, the data structure further specifying the at least one configured condition.

17. The platform of claim 13, wherein the one or more conditions relate to user behavior with respect to the current or a preceding activity.

18. The platform of claim 13, wherein the one or more conditions depend upon a context of the experience.

19. The platform of claim 13, at least one of the one or more memories storing at least one instruction for evaluating satisfaction of the one or more conditions in sequential order.

20. The platform of claim 1, the data structure specifying one or more conditions for controlling transition from a first user workflow associated with a first user to a second user workflow associated with a second user, based at least in part upon satisfaction of one of the one or more conditions.

21. The platform of claim 20, wherein the one or more conditions are based upon a context of the experience.

22. The platform of claim 20, at least one of the one or more memories storing at least one instruction for evaluating satisfaction of the one or more conditions in sequential order.

23. The platform of claim 22, wherein configuring the one or more conditions is based at least in part upon selection from a plurality of condition options displayed on a GUI.

24. A computer-implemented method for for enabling an administrator to configure an experience, wherein the experience comprises a plurality of sequential workflows, each workflow comprises a plurality of sequential activities specific to a user, and each activity corresponds to a screen for interfacing with a corresponding user on a corresponding graphical user interface (GUI), the method comprising:
configuring, using a processor, at least one screen element within an activity screen template, that is displayed on a GUI, in response to administrator input representing interaction of the administrator with at least one template screen element; and
storing a data structure for at least one activity in at least one of the workflows, the data structure for specifying, for display to the user on a screen, the at least one configured screen element.

25-31. (canceled)

32. The method of claim 24, comprising configuring a workflow in response to selection for inclusion, in a workflow, of one or more activity templates from a plurality of activity template options displayed on a GUI.

33-35. (canceled)

36. The method of claim 24, the data structure further specifying one or more conditions for determining a next activity to perform based at least in part upon one of the one or more conditions being satisfied.

37-42. (canceled)

43. The method of claim 24, the data structure specifying one or more conditions for controlling transition from a first user workflow associated with a first user to a second user workflow associated with a second user, based at least in part upon satisfaction of one of the one or more conditions.

44-46. (canceled)

47. One or more non-transitory computer-readable media storing instructions that, when executed by one or more computing devices, cause at least one of the one or more computing devices to:
configure at least one screen element within an activity screen template, that is displayed on a GUI, in response to administrator input representing interaction of the administrator with at least one template screen element; and
store a data structure for at least one activity in at least one of the workflows, the data structure for specifying, for display to the user on a screen, the at least one configured screen element.

48-54. (canceled)

55. The computer-readable media of claim 47, storing at least one instruction that, when executed by one or more computing devices, causes at least one of the one or more computing devices to configure a workflow in response to selection for inclusion, in a workflow, of one or more activity templates from a plurality of activity template options displayed on a GUI.

56-58. (canceled)

59. The computer-readable media of claim 47, the data structure further specifying one or more conditions for determining a next activity to perform based at least in part upon one of the one or more conditions being satisfied.

60-65. (canceled)

66. The computer-readable media of claim 47, the data structure specifying one or more conditions for controlling transition from a first user workflow associated with a first user to a second user workflow associated with a second user, based at least in part upon satisfaction of one of the one or more conditions.

67.-69. (canceled)
